(19) United States
(12) Patent Application Publication
(10) Pub. No.: US 2025/0118456 A1
(43) Pub. Date: Apr. 10, 2025

(54) POTTED WIRE ENCASEMENT FOR ENVIRONMENTAL PROTECTION

(71) Applicant: Polaris Industries Inc., Medina, MN (US)

(72) Inventors: Brian E. Brandt, Roseau, MN (US); Cory Huot, Roseau, MN (US); Trevor F. Rhodes, Wyoming, MN (US); Michael A. Hedlund, Roseau, MN (US); Joseph P. Wood, Wyoming, MN (US); Dustin Mertens, Roseau, MN (US); Virendra Kumar Gupta, Roseau, MN (US); Austin A. Linder, Roseau, MN (US)

(73) Assignee: Polaris Industries Inc., Medina, MN (US)

(21) Appl. No.: 18/903,467

(22) Filed: Oct. 1, 2024

Related U.S. Application Data
(60) Provisional application No. 63/542,805, filed on Oct. 6, 2023.

(51) Int. Cl. H01B 7/24; B60R 16/02; B62J 45/00; B62M 27/02; H01B 7/00

(52) U.S. Cl. CPC H01B 7/24; B62J 45/00; H01B 7/0045; B60R 16/0215; B62M 27/02

(57) ABSTRACT

A shock control cable assembly for a vehicle includes a routing guide including a channel configured to receive conductors of a main cable that connects to a shock control module, conductors of a first shock cable that connects to a first shock, and conductors of a second shock cable that connect to a second shock. At least one of the conductors of the main cable is connected to each of the first shock cable and the second shock cable within the channel. The routing guide further including a first flange having a first opening to receive a first fastener to secure the routing guide to a first member of a rear suspension of the vehicle. Potting material is injected into the channel to encapsulate the conductors of the main cable, the first shock cable, and the second shock cable to protect the conductors from environmental conditions.

### CROSS-REFERENCE TO RELATED APPLICATION

The present application claims priority to U.S. Provisional Patent Application No. 63/542,805, filed Oct. 6, 2023, the entire disclosure of which is incorporated herein by reference.

### BACKGROUND

Control signals for various components of vehicle are routed through cables from one component of the vehicle to one or more other components. In some vehicles, there is limited space to route such cables, and the connectors on the cables may need to be precisely located. Moreover, some vehicles are operated in harsh environments, so the cables and connections between the cables are exposed to those harsh environments.

### SUMMARY

According to one embodiment of the present disclosure, a shock control cable assembly for a vehicle is provided. The assembly includes a routing guide including a channel configured to receive conductors of a main cable configured to connect to a shock control module, conductors of a first shock cable configured to connect to a first shock of the vehicle, and conductors of a second shock cable configured to connect to a second shock of the vehicle, at least one of the conductors of the main cable being connected to each of the first shock cable and the second shock cable within the channel. The routing guide further includes a first flange having a first opening to receive a first fastener to secure the routing guide to a first member of a rear suspension of the vehicle. The assembly also includes potting material injected into the channel to encapsulate the conductors of the main cable, the conductors of the first shock cable, and the conductors of the second shock cable to protect the conductors from environmental conditions.

According to another embodiment, the present disclosure provides a shock control cable assembly for a vehicle that includes a main cable having a first end, a second end, and a first connector at the first end, the first connector being adapted to connect to a shock control module of the vehicle, a first shock cable having a first end, a second end, and a second connector at the first end, the second connector being adapted to connect to a first shock of the vehicle, a second shock cable having a first end, a second end, and a third connector at the first end, the third connector being adapted to connect to a second shock of the vehicle, a routing guide including a main body and an inlet arm. The main body includes an upper wall including a clip configured to attach to a first member of a rear suspension of the vehicle and a first opening which receives the second end of the first shock cable, a lower wall including a first flange having an opening configured to receive a fastener to secure the main body to a second member of the rear suspension, a connecting wall extending between the upper wall and the lower wall, the upper wall, the lower wall, and the connecting wall together defining a channel, and an outlet formed by the upper wall, the lower wall, and the connecting wall, the outlet receiving the second end of the second shock cable. The inlet arm includes a second opening which receives the second end of the main cable. The second end of the main cable is connected to the second end of the first shock cable and the second end of the second shock cable within the channel of the main body of the routing guide. The assembly also includes potting material injected into the channel of the main body to encapsulate the second end of the main cable, the second end of the first shock cable, and the second end of the second shock cable.

According to yet another embodiment of the present disclosure, a method of routing control signals from a shock control module of a vehicle to a first shock and a second shock is provided. The method includes providing a routing guide having a channel, a clip and a flange, forming a main cable to extend from the shock control module to the routing guide, forming a first shock cable to extend from the first shock of the vehicle to the routing guide, forming a second shock cable to extend from the second shock of the vehicle to the routing guide, routing conductors of the main cable, the first shock cable, and the second shock cable into the routing guide, connecting the conductors of the main cable to the conductors of the first shock cable and the conductors of the second shock cable, inserting the connected conductors into the channel of the routing guide, placing the routing guide in a fixture, injecting potting material into the channel to encapsulate the connected conductors, clipping the clip of the routing guide to a first member of a rear suspension of the vehicle to position the routing guide, installing a bolt through the flange of the routing guide into a second member of the rear suspension to secure the routing guide, connecting the main cable to the shock control module, connecting the first shock cable to the first shock, and connecting the second shock cable to the second shock.

### BRIEF DESCRIPTION OF THE DRAWINGS

The above-mentioned and other advantages and objects of this disclosure, and the manner of attaining them, will become more apparent, and the disclosure itself will be better understood, by reference to the following description of embodiments of the invention taken in conjunction with the accompanying drawings, wherein:

FIG. 1 is a perspective view of a vehicle;

FIG. 2 is a perspective view of a shock control cable assembly according to one embodiment of the present disclosure;

FIG. 3 is a schematic diagram of the shock control cable assembly of FIG. 2;

FIG. 4 is a side plan view of a shock control cable assembly according to another embodiment of the present disclosure;

FIG. 5 is a perspective view of the shock control cable assembly of FIG. 2;

FIG. 6 is a perspective view of a portion of the shock control cable assembly of FIG. 4;

FIG. 7 is a side plan view of the shock control cable assembly of FIG. 4 mounted to a vehicle;

FIGS. 8 and 9 are perspective views of the shock control cable assembly of FIG. 4 mounted to a vehicle;

FIG. 10 is a side plan view of the shock control cable of FIG. 2 before potting material is injected into the routing guide;

FIG. 11 is a perspective view of a fixture for injecting potting material into a shock control cable assembly according to the present disclosure;

FIG. 12 is a perspective view of the shock control cable assembly of FIG. 5 after potting material is injected into the routing guide; and

FIG. 13 is a flow chart of steps in a method according to the present disclosure.

Corresponding reference characters indicate corresponding parts throughout the several views. Although the drawings represent embodiments of the present disclosure, the drawings are not necessarily to scale, and certain features may be exaggerated or omitted in some of the drawings in order to better illustrate and explain the present disclosure.

### DETAILED DESCRIPTION

In one aspect of the present disclosure, the cables that connect the shock control module and the center and rear shocks of a snowmobile are connected together at a routing guide. The connections are contained within a channel of the routing guide and then encapsulated by potting material, which protects the connections and the cables from environmental conditions.

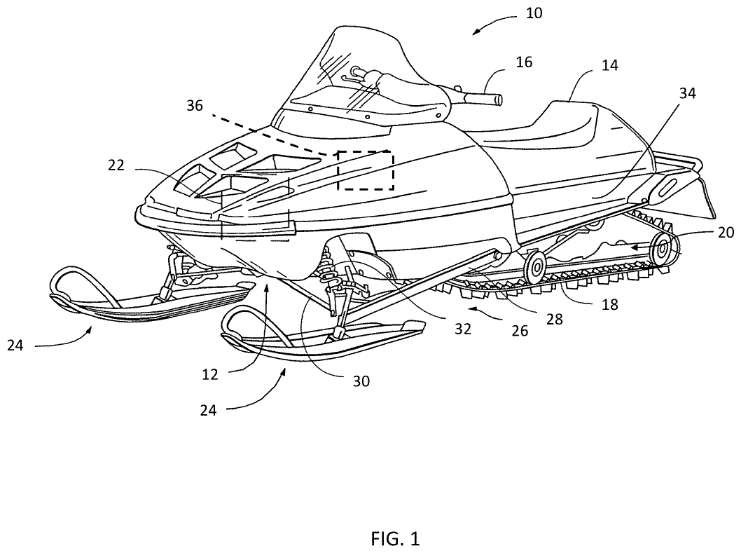

Referring now to FIG. 1, a snowmobile 10 is depicted including a chassis 12, a straddle type seat 14 mounted to the chassis 12, and a pair of handlebars 16 carried by the chassis 12 adjacent to the seat 14 so that a rider sitting in straddle fashion on the seat 14 may steer the snowmobile 10 using the handlebars 16. The snowmobile 10 includes an endless track 18 carried by a rear suspension 20 or skid mounted to the chassis 12, the endless track 18 being connected to and powered by the snowmobile's engine 22 (typically located beneath the hood near the front of the snowmobile). A fuel tank (not shown) may be located under the seat.

Left and right steerable skis 24 are carried by a front suspension system 26, which in turn is mounted to the chassis 12. The suspension system may be of any suitable type. In the drawings a trailing arm suspension system is depicted, such a system utilizing, for each ski, a trailing arm 28 connected at its rear end to the chassis 12, a pair of generally transversely mounted radius arms 30 connected at their inner ends to the chassis 12 and at their outer ends to the frond end of the trailing arm, and a shock/spring combination 32 connected at one end to the chassis 12 and at the other end to the front end of the trailing arm 28. Other suitable suspensions could also be utilized, however, including, e.g., a double A-arm suspension or a telescopic strut suspension.

The chassis 12 forms a tunnel 34 at the rear of the vehicle 10 which connects to the rear suspension 20 and receives at least a portion of the endless track 18. The chassis 12 also includes a front chassis portion which retains the power train (not shown). A drive shaft (not shown) is typically mounted to the front chassis portion and includes drive sprockets for powering the endless track 18.

The vehicle 10 further includes an engine control module (not shown) which monitors and controls various electrically controlled functions of the vehicle 10. In the embodiment described, the vehicle further includes a shock control module 36 (shown in dotted lines in FIG. 1). In vehicles including active rear suspension, the shock control module 36 receives inputs indicative of various parameters of the vehicle's current operation and provides control signals to the center and rear shocks (described below) of the rear suspension 20 to adapt to the current operating environment. For example, the shock control module 36 receives inputs representative of the forces imparted to the vehicle from the terrain and controls the operation of the shocks in response to improve rider comfort and vehicle performance.

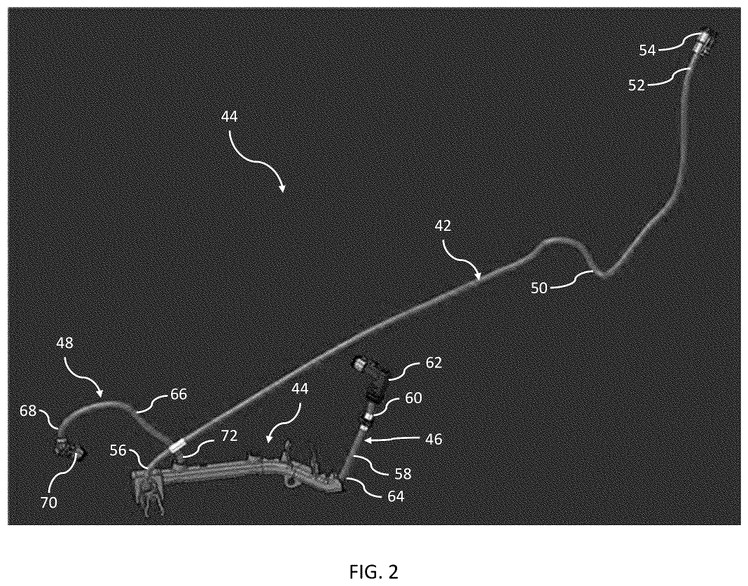

Referring now to FIG. 2, a shock control cable assembly 40 is shown. In general, the shock control cable assembly 40 includes a main cable 42, a routing guide 44, a center shock cable 46 and a rear shock cable 48. The main cable 42 includes a body 50 having a first end 52 which includes a connector 54 configured to mate with a connector coupled to the shock control module 36. The body 50 further includes a second end 56 that extends into the routing guide 44 as is further described below. As is also further described below, in one embodiment the main cable 42 encases three conductors, including a common power conductor, a center shock conductor and a rear shock conductor. In other embodiments, the main cable 42 may include more or fewer conductors.

The center shock cable 46 includes a body 58 having a first end 60 which includes a connector 62 configured to mate with a connector coupled to the center shock of the vehicle 10. The second end 64 of the center shock cable 46 extends into the routing guide 44 as is further described below. In certain embodiments, the center shock cable 46 encases two conductors; a common power conductor and a center shock conductor. Similarly, the rear shock cable 48 includes a body 66 having a first end 68 which includes a connector 70 configured to mate with a connector coupled to the rear shock of the vehicle 10. The second end 72 of the rear shock cable 48 extends into the routing guide 44 as is further described below. In certain embodiments, the center shock cable 46 encases two conductors; a common power conductor and a rear shock conductor. In certain embodiments, the connectors 54, 62 and 70 may be environmentally sealed, waterproof electrical connectors such as connectors manufactured by Deutsch IPD based in California.

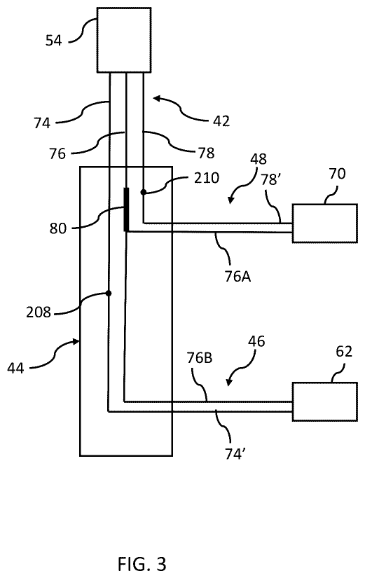

As shown schematically in FIG. 3, the main cable 42 routes the center shock conductor 74, the common power conductor 76 and the rear shock conductor 78 from the connector 54 into the routing guide 44. As indicated herein, in certain embodiments the shock control module 36 provides varying levels of current to the center shock 174 and the rear shock 176 over the center shock conductor 74 and the rear shock conductor 78, respectively, to adapt the performance of the shocks to the current operating environment of the vehicle 10. The center shock conductor 74 of the main cable 42 is connected at connection 208 to the center shock conductor 74′ of the center shock cable 46. Similarly, the rear shock conductor 78 of the main cable 42 is connected at connection 210 to the rear shock conductor 78′ of the rear shock cable 48. A splice 80 in the routing guide 44 connects the common power conductor 76 to two conductors; common power conductor 76A and common power conductor 76B. The common power conductor 76A and the rear shock conductor 78′ are routed out of the routing guide 44 through the rear shock cable 48 to the connector 70. The center shock conductor 74′ and the common power conductor 76B are routed out of the routing guide 44 through the center shock cable 46.

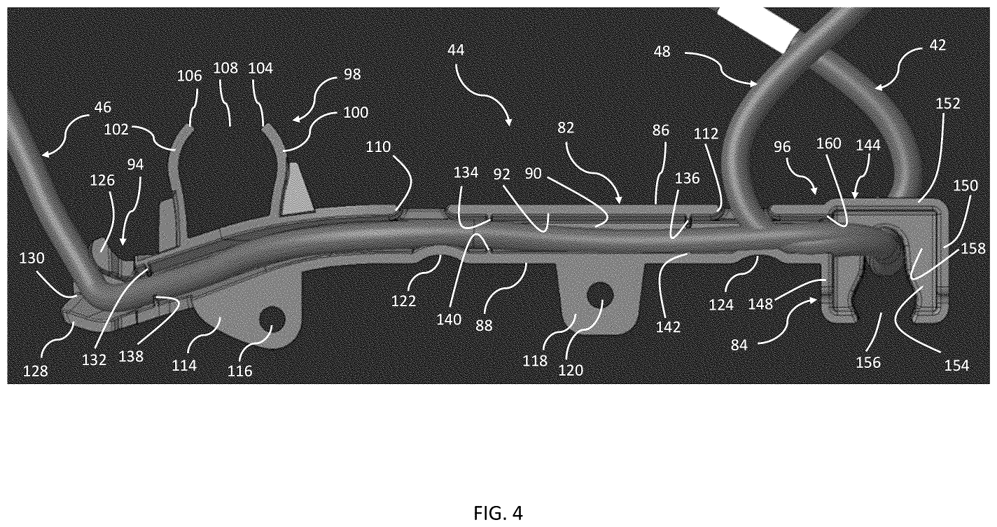

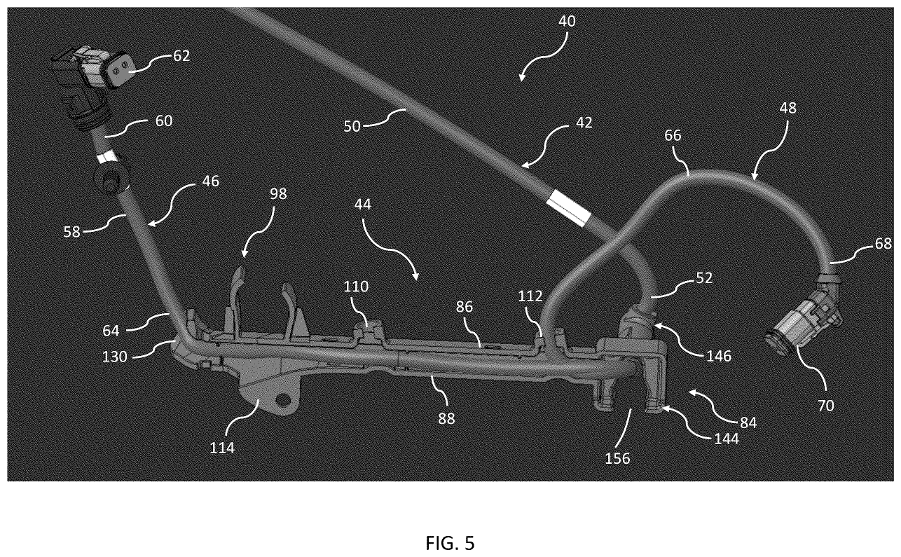

Referring now to FIGS. 4 through 6, the routing guide 44 of the shock control cable assembly 40 according to one embodiment of the present disclosure generally includes a main body 82 and an inlet arm 84. In certain embodiments, the main body 82 is formed from plastic such as nylon. In other embodiments, the main body 82 is formed from one or more other materials. The main body 82 includes an upper wall 86, a lower wall 88 and a connecting wall 90 extending between the upper wall 86 and the lower wall 88. Together, the upper wall 86, the lower wall 88 and the connecting wall 90 form a channel 92 that extends between a forward end 94 of the main body 82 and a rearward end 96 of the main body 82.

The main body 82 also includes a clip 98 extending from the upper wall 86 for clipping the routing guide 44 to a front tube 188 of an H bracket assembly 180 of the rear suspension 20 as is further described below. The clip 98 include a curved first arm 100 and an opposing curved second arm 102. The first arm 100 includes an outer end 104 and the second arm includes an outer end 106. The outer ends 104, 106 are spaced apart from one another to form a gap 108. As is further described below, the arms 100, 102 are somewhat resilient such that gap 108 can expand to receive the front tube 188 and then return to its original size, thereby clipping the routing guide 44 to the front tube 188.

The main body 82 of the routing guide 44 also includes a forward opening 110 in the upper wall 86 and a rearward opening 112 in the upper wall 86. In the figures, the rear shock cable 48 is shown extending from the channel 92 of the main body 82 through the rearward opening 112. In other applications where the vehicle 10 has a shorter track length (i.e., a shorter endless track 18 and therefore a rear shock that is closer to the center shock), the rear shock cable 48 may extend through the forward opening 110.

A forward flange 114 extends substantially perpendicularly from the lower wall 88 of the main body 82 adjacent the forward end 94 of the main body 82. The forward flange 114 includes an opening 116 configured to receive a bolt (not shown) for securing the routing guide 44 to the H bracket assembly 180 of the rear suspension 20 as is further described below. A rearward flange 118 also extends substantially perpendicularly from the lower wall 88 adjacent the rearward end 96 of the main body 82. The rearward flange 118 also includes an opening 120 configured to receive a bolt (not shown) for securing the routing guide 44 to the H bracket assembly 180 of the rear suspension 20 as is further described below. Finally, the lower wall 88 also includes a forward recess 122 and a rearward recess 124. The recesses 122, 124 are configured to provide clearance for bolts that are part of the H bracket assembly 180.

At the forward end 94 of the main body 82 of the routing guide 44, the upper wall 86 includes a curved section 126, the lower wall 88 includes a curved section 128, and the connecting wall 90 extends between the curved sections 126, 128. Together, the curved sections 126, 128 and the connecting wall 90 form an outlet 130 for the center shock cable 46.

The upper wall 86 further includes a forward inwardly directed rib 132, a central inwardly directed rib 134, and a rearward inwardly directed rib 136. The lower wall 88 similarly includes a forward inwardly directed rib 138, a central inwardly directed rib 140, and a rearward inwardly directed rib 142. The forward inwardly directed rib 132 of the upper wall 86 extends into the channel 92 in substantial alignment with the forward inwardly directed rib 138 of the lower wall 88. The central inwardly directed rib 134 of the upper wall 86 extends into the channel 92 in substantial alignment with the central inwardly directed rib 140 of the lower wall 88. The rearward inwardly directed rib 136 of the upper wall 86 extends into the channel 92 in substantial alignment with the rearward inwardly directed rib 142 of the lower wall 88. The opposed forward rib pairs 132, 138, the opposed central rib pairs 134, 140, and the opposed rearward rib pairs 136, 142 are positioned and sized to retain the splice 80 and center shock cable 46 in place in the channel 92 of the routing guide 44 as potting material is introduced into the channel 92 as is further described below.

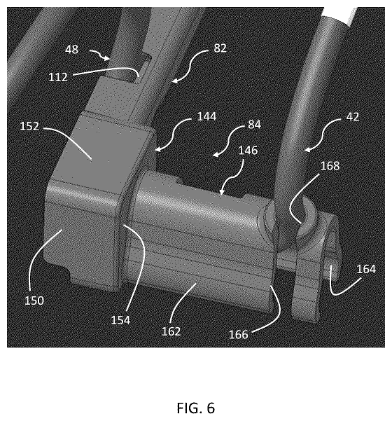

The inlet arm 84 of the routing guide 44 generally includes a junction 144 extending from the main body 82 adjacent the rearward end 96 and an extension 146 (best shown in FIG. 6) extending from the junction 144 substantially perpendicularly relative to the connecting wall 90 of the main body 82. The junction 144 includes a forward wall 148, a rearward wall 150, an upper wall 152, and a web 154 extending inwardly from the forward wall 148, the rearward wall 150 and the upper wall 152. The web 154 defines a cable opening 156 for receiving the main cable 42 as is further described below. The forward wall 148, the rearward wall 150, the upper wall 152 and the web 154 together define a partially enclosed inner volume 158 in communication with the channel 92 of the main body 82 through an interface opening 160.

Referring now primarily to FIG. 6, the extension 146 of the inlet arm 84 includes clip shaped wall 162 having an inner surface 164 that is substantially the same shape as the cable opening 156 of the web 154. A slot 166 is formed in the clip shaped wall 162 to receive the main cable 42. The clip shaped wall 162 also includes a main cable opening 168 sized to receive and position the main cable 42.

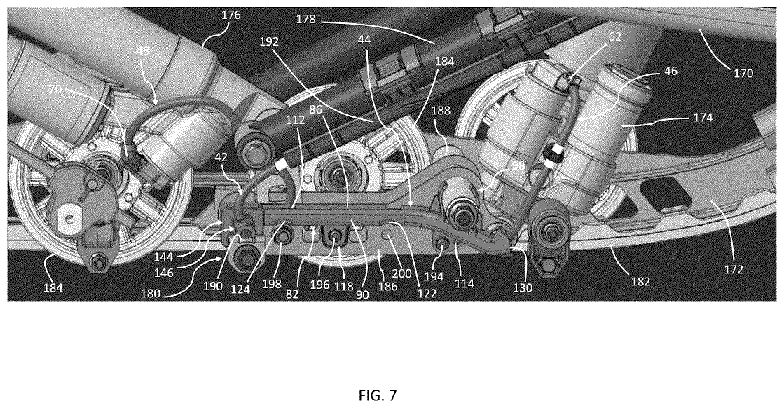

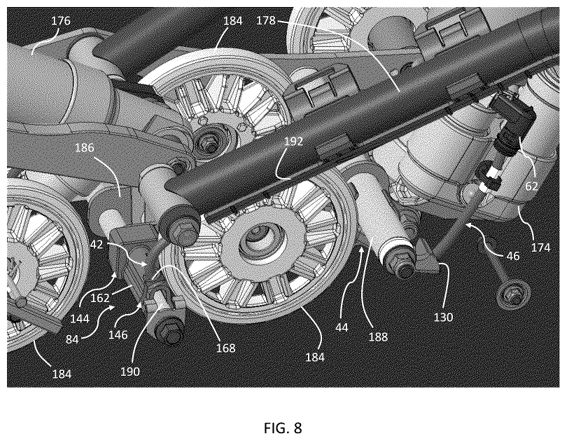

Referring now to FIGS. 7 and 8, the shock control cable assembly 40 is shown installed on the vehicle 10 with several parts of the vehicle not shown for clarity. The rear suspension 20 includes a plurality of frame members 170 that connect the chassis 12 to the rear suspension 20. The slide rails 172 (one shown) of the rear suspension are movably connected to the frame members 170 through, among other things, a center shock 174, a rear shock 176, a pair of front arms 178 and an H bracket assembly 180. A pair of track sliders 182 (one shown) are coupled to the slide rails 172 and, along with a plurality of track rollers 184, guide the movement of the endless track 18 (FIG. 1). The H bracket assembly 180 includes a pair of plates 186, the front tube 188, and the rear tube 190, which each are connected to and span between the plates 186.

After the assembly process is performed as described below, the shock control cable assembly 40 is installed on the vehicle 10 by connecting the connector 54 of the main cable 42 to the shock control module 36 and routing the main cable 42 along the front arm 178 through the tunnel 34. The main cable 42 is held in position on the front arm 178 by a clamp 192 which partially encircles the front arm 178 and includes a groove for receiving the main cable 42. The clip 98 of the routing guide 44 is clipped over the front tube 188 of the H bracket assembly 180 as shown. The clip shaped wall 162 of the extension 146 of the inlet arm 84 is clipped over the rear tube 190 of the H bracket assembly 180 as shown. The clip 98 and the clip shaped wall 162 hold the routing guide 44 is position so that a bolt 194 may be passed through the opening 116 of the forward flange 114 of the lower wall 88 of the routing guide 44 and threaded into the plate 186 of the H bracket assembly 180. Another bolt 196 may be passed through the opening 120 of the rearward flange 118 of the lower wall 88 of the routing guide 44 and threaded into the plate 186 of the H bracket assembly 180 in a similar manner. The bolts 194, 196 secure the routing guide 44 to the plate 186 of the H bracket assembly 180. When the routing guide 44 is secured, the preformed shape of the center shock cable 46 positions the connector 62 appropriately to be connected to the center shock 174. Similarly, the preformed shape of the rear shock cable 48 positions the connector 70 appropriately to be connected to the rear shock 176. As shown, the rearward recess 124 of the lower wall 88 of the routing guide 44 provides clearance for another bolt 198 connected to the H bracket assembly 180 and the forward recess 122 of the lower wall 88 of the routing guide 44 provides clearance for another bolt (not shown) that extends through an opening 200 in the plate 186 of the H bracket assembly 180.

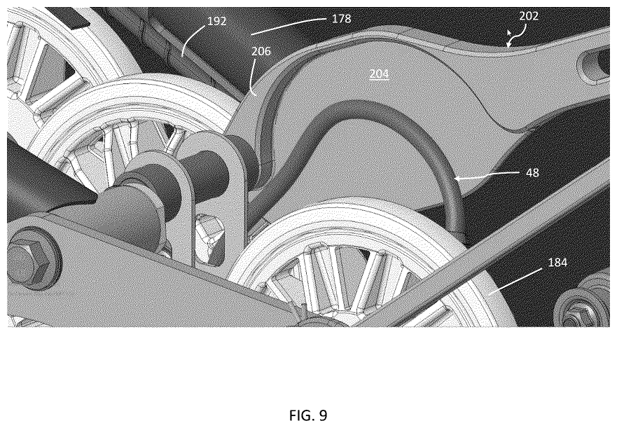

As best shown in FIG. 9, one of the frame members of the rear suspension 20 is a pole rod 202. The rear shock cable 48 extends from the routing guide 44 into a recess 204 formed into an outer wall 206 the pole rod 202 to reach the rear shock 176.

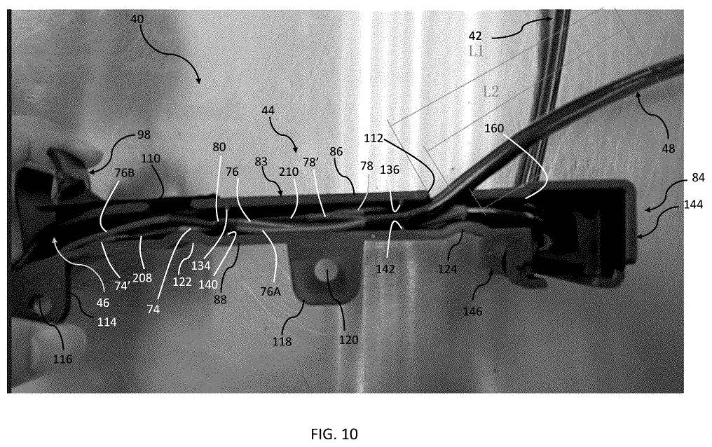

Referring now to FIG. 10, the shock control cable assembly 40 is shown prior to potting. The main cable 42 is shown passing through the extension 146 of the inlet arm 84 of the routing guide 44 and through the junction 144 and interface opening 160. The center shock conductor 74 of the main cable 42 is connected to the center shock conductor 74′ of the center shock cable 46 at connection 208, and the rear shock conductor 78 of the main cable 42 is connected to the rear shock conductor 78′ of the rear shock cable 48 at connection 210. Additionally, the common power conductor 76 is connected to the common power conductor 76A of the rear shock cable 48 and the common power conductor 76B of the center shock cable 46 at the splice 80. As indicated above, the opposed pair of forward inwardly directed ribs 132, 138, the opposed pair of central inwardly directed ribs 134, 140, and the opposed pair of rearward inwardly directed ribs 136, 142 retain the various conductors in place in the channel 92 of the main body 82 of the routing guide 44 after the connections are made. In the state depicted in FIG. 10, the routing guide 44 is ready for potting.

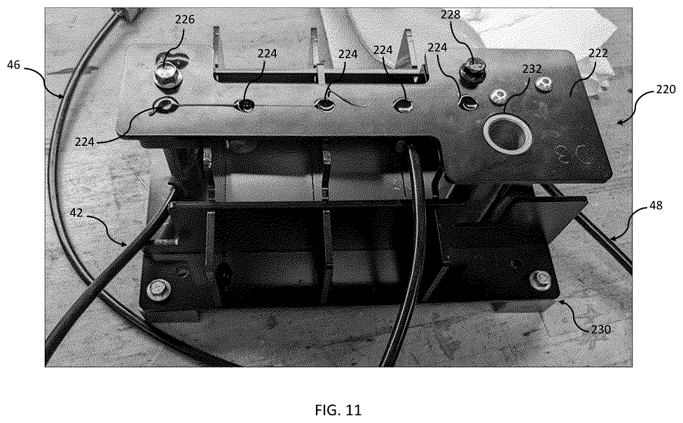

Referring now to FIG. 11, a fixture 220 for inserting potting material into the routing guide 44 is shown. The fixture 220 includes a top plate 222 with a plurality of injection openings 224. In the depicted embodiment five injection openings 224 are shown. It should be understood, however, that more or fewer injection openings 224 may be provide in other embodiments. The top plate 222 further includes a pair of bolts 226, 228 for tightening the top plate 222 to a base 230 of the fixture 220.

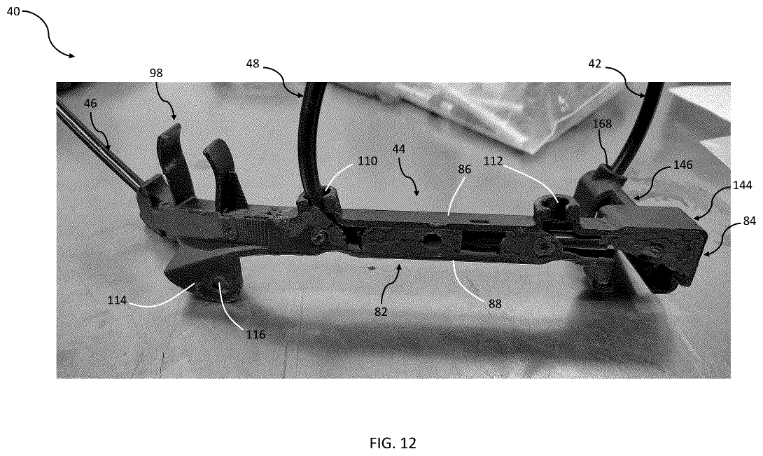

To insert the potting material into the routing guide 44, the top plate 222 is removed from the base 230 of the fixture 220. After connecting the conductors of the cables 42, 46, and 48 as described above, and installation of the cables 42, 46, and 48 into the channel 92 of the main body 82 of the routing guide 44, the shock control cable assembly 40 is installed in the base 230 of the fixture 222 with the channel 92 facing upwardly. The shock control cable assembly 40 is positioned in the fixture 220 by attaching the clip 98 of the upper wall 86 of the main body 82 to a rod 232 mounted in the fixture 220. The clip shaped wall 162 of the extension 146 is clipped onto a shaft (not shown) that the bolt 226 threads into. The top plate 222 is then attached to the base 230 using the bolts 226, 228, which are tightened into threaded openings (not shown) of the base 230 to clamp the routing guide 44 in place. Finally, potting material 234 is injected into the plurality of injection openings 224 to fill the voids in the channel 92, the outlet 130, the inner volume 158 of the junction 144, and the interior of the clip shaped wall 162 of the extension 146. In this manner the potting material 234 encapsulates the cables, their conductors and connections and the splice. In one embodiment of the present disclosure, the potting material 234 is a two-part unfilled epoxy adhesive that cures to polymers to provide protection against water, humidity, salt spray and other chemicals. The potting material 234 may be sufficiently soft to permit some flexibility at extreme cold temperatures. One example is EP1225 Black, which is manufactured by Resinlab™. FIG. 12 depicts the shock control cable assembly 40 with potting material 234 installed.

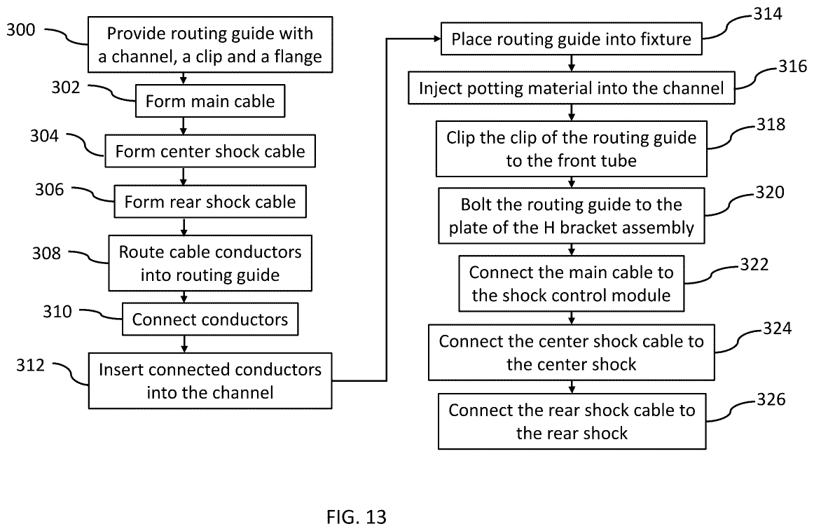

In one embodiment, control signals are routed from the shock control module 36 to the rear shock 176 and the center shock 174 of the vehicle 10 according to the process depicted in FIG. 13. At step 300, the routing guide 44 is provided with the channel 92, at least the forward flange 114, and the clip 98. At step 302, the main cable 42 is formed to extend from the shock control module 36 to the routing guide 44 according to the geometry of the vehicle 10. At step 304, the center shock cable 46 is formed to extend from the center shock 174 to the routing guide 44 according to the geometry of the vehicle 10. At step 306, the rear shock cable 48 is formed to extend from the rear shock 176 to the routing guide 44 according to the geometry of the vehicle 10. At step 308, the conductors 74, 76, ad 78 of the main cable 42 are routed into the routing guide 44 through the slot 166, the main cable opening 168 and the interface opening 160. The conductors 74′ and 76B of the center shock cable 46 are routed into the routing guide 44 through the outlet 130, and the conductors 74 and 76A of the rear shock cable 48 are routed into the routing guide 44 through one of the forward opening 110 or the rearward opening 112 of the upper wall 86 of the routing guide 44. At step 310, the conductors of the main cable 42, the center shock cable 46 and the rear shock cable 48 are connected in the manner described herein. At step 312, the connected conductors are inserted into the channel 92 of the routing guide 44 and retained in place by the opposing pairs of inwardly directed ribs 132, 138, 134, 140, and 136, 142. At step 314, the routing guide 44 is placed in the fixture 220, and at step 316 the potting material 234 is injected into the channel 92 of the routing guide 44 to encapsulate the connected conductors. The shock control cable assembly 40 is then attached to the vehicle by clipping the clip 98 of the routing guide 44 to the front tube 188 of the H bracket assembly 180 at step 318. At step 320, the routing guide 44 is bolted to the plate 186 of the H bracket assembly 180 by threading the bolt 196 through the opening 116 of the flange 114 and into a corresponding opening in the plate 186. At step 322, the connector 54 of the main cable 42 is connected to the shock control module 36. At step 324, the connector 62 of the center shock cable 46 is connected to the center shock 174. At step 326, the connector 70 of the rear shock cable 48 is connected to the rear shock 176.

It should be noted that variations of the routing guide 44 of the present disclosure are depicted throughout the several views. For example, FIGS. 2, 5 and 12 omits the rearward flange 118 and includes guide walls at the forward opening 110 and the rearward opening 112, whereas the other figures do not. FIGS. 2 and 12 also shows the rear shock cable 48 exiting the channel 92 through the forward opening 110, whereas the other figures do not. It should be understood that in certain embodiments the rearward flange 118 and the guide walls may be optional. As indicated above, depending upon the length of the endless track 18, the rear shock cable 48 may exit the channel 92 of the routing guide 44 through the forward opening 110 or the rearward opening 112 to accommodate the different locations of the rear shock 176.

Any directional references used with respect to any of the figures, such as right or left, up or down, or top or bottom, are intended for convenience of description, and do not limit the present disclosure or any of its components to any particular positional or spatial orientation. Additionally, any reference to rotation in a clockwise direction or a counterclockwise direction is simply illustrative. Any such rotation may be implemented in the reverse direction as that described herein.

Although the foregoing text sets forth a detailed description of embodiments of the disclosure, it should be understood that the legal scope of the invention is defined by the words of the claims set forth at the end of this patent and equivalents. The detailed description is to be construed as exemplary only and does not describe every possible embodiment. Numerous alternative embodiments may be implemented, using either current technology or technology developed after the filing date of this patent, which would still fall within the scope of the claims.

The following additional considerations apply to the foregoing description. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Additionally, some embodiments may be described using the expression “communicatively coupled,” which may mean (a) integrated into a single housing, (b) coupled using wires, or (c) coupled wirelessly (i.e., passing data/commands back and forth wirelessly) in various embodiments.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112 (f) unless traditional means-plus-function language is expressly recited, such as “means for” or “step for” language being explicitly recited in the claim(s).

The following clauses illustrate example subject matter described herein:
Clause 1: A shock control cable assembly for a vehicle, comprising: a routing guide including a channel configured to receive conductors of a main cable configured to connect to a shock control module, conductors of a first shock cable configured to connect to a first shock of the vehicle, and conductors of a second shock cable configured to connect to a second shock of the vehicle, at least one of the conductors of the main cable being connected to each of the first shock cable and the second shock cable within the channel, the routing guide further including a first flange having a first opening to receive a first fastener to secure the routing guide to a first member of a rear suspension of the vehicle; and potting material injected into the channel to encapsulate the conductors of the main cable, the conductors of the first shock cable, and the conductors of the second shock cable to protect the conductors from environmental conditions.
Clause 2: The shock control cable assembly of clause 1, wherein the routing guide includes a main body having an upper wall, a lower wall, and a connecting wall extending between the upper wall and the lower wall, wherein together the upper wall, the lower wall, and the connecting wall define the channel.
Clause 3: The shock control cable assembly of clause 2, wherein the upper wall includes a clip configured to attach the routing guide to a second member of the rear suspension.
Clause 4: The shock control cable assembly of clause 2 of 3, wherein the upper wall includes a first opening configured to receive the first shock cable for a first vehicle and a second opening configured to receive the first shock cable for a second vehicle.
Clause 5: The shock control cable assembly of any of clauses 2 through 4, wherein the upper wall, the lower wall, and the connecting wall define an outlet configured to receive the second shock cable.
Clause 6: The shock control cable assembly of any of clauses 2 through 5, wherein the first flange extends from the lower wall of the routing guide.
Clause 7: The shock control cable assembly of any of clauses 2 through 6, wherein the routing guide includes a second flange extending from the lower wall, the second flange including a second opening to receive a second fastener to secure the routing guide to the first member of the rear suspension.
Clause 8: The shock control cable assembly of any of clauses 2 through 7, wherein the routing guide further includes an inlet arm extending from the main body, the inlet arm having a main cable opening configured to receive the main cable.
Clause 9: The shock control cable assembly of clause 8, wherein the inlet arm includes a junction extending from the main body and an extension extending from the junction substantially perpendicular to the main body, the extension having a clip shaped wall configured to attach the routing guide to a third member of the rear suspension.
Clause 10: The shock control cable assembly of any of clauses 1 through 9, wherein the routing guide further includes a second flange having a second opening to receive a second fastener to secure the routing guide to the first member of the rear suspension, a clip configured to attach the routing guide to a second member of the rear suspension, and a clip shaped wall configured to attach the routing guide to a third member of the rear suspension.
Clause 11: The shock control cable assembly of clause 10, wherein the first member of the rear suspension is a plate of an H bracket assembly, the second member is a front tube of the H bracket assembly, and the third member is a rear tube of the H bracket assembly.
Clause 12: The shock control cable assembly of any of clauses 1 through 11, wherein the at least one of the conductors of the main cable is a common power conductor, the common power conductor being connected to the first shock cable and the second shock cable at a splice encapsulated within the potting material.
Clause 13: The shock control cable assembly of any of clauses 1 through 12, wherein the potting material is a two-part unfilled epoxy adhesive that cures to polymers, and the routing guide is formed from nylon.
Clause 14: The shock control cable assembly of any of clauses 1 through 13, wherein the first shock of the vehicle is a rear shock and the second shock of the vehicle is a center shock.
Clause 15: The shock control cable assembly of any of clauses 1 through 14, wherein the vehicle is a snowmobile.
Clause 16: A shock control cable assembly for a vehicle, comprising: a main cable having a first end, a second end, and a first connector at the first end, the first connector being adapted to connect to a shock control module of the vehicle; a first shock cable having a first end, a second end, and a second connector at the first end, the second connector being adapted to connect to a first shock of the vehicle; a second shock cable having a first end, a second end, and a third connector at the first end, the third connector being adapted to connect to a second shock of the vehicle; a routing guide including a main body and an inlet arm; wherein the main body includes: an upper wall including a clip configured to attach to a first member of a rear suspension of the vehicle and a first opening which receives the second end of the first shock cable; a lower wall including a first flange having an opening configured to receive a fastener to secure the main body to a second member of the rear suspension; a connecting wall extending between the upper wall and the lower wall, the upper wall, the lower wall, and the connecting wall together defining a channel; and an outlet formed by the upper wall, the lower wall, and the connecting wall, the outlet receiving the second end of the second shock cable; wherein the inlet arm includes a second opening which receives the second end of the main cable; wherein the second end of the main cable is connected to the second end of the first shock cable and the second end of the second shock cable within the channel of the main body of the routing guide; and potting material injected into the channel of the main body to encapsulate the second end of the main cable, the second end of the first shock cable, and the second end of the second shock cable.
Clause 17: The shock control cable assembly of clause 16, wherein the upper wall includes a second opening configured to receive the first shock cable.
Clause 18: The shock control cable assembly of clause 16 of 17, wherein the routing guide includes a second flange extending from the lower wall, the second flange including a second opening to receive a second fastener to secure the routing guide to the second member of the rear suspension.
Clause 19: The shock control cable assembly of any of clauses 16 through 18, wherein the inlet arm includes a junction extending from the main body and an extension extending from the junction substantially perpendicular to the main body, the extension having a clip shaped wall configured to attach the routing guide to a third member of the rear suspension.
Clause 20: The shock control cable assembly of clause 19, wherein the first member of the rear suspension is a front tube of an H bracket assembly, the second member is a plate of the H bracket assembly, and the third member is a rear tube of the H bracket assembly.
Clause 21: The shock control cable assembly of any of clauses 16 through 19, wherein the main cable includes a common power conductor, the common power conductor being connected to the first shock cable and the second shock cable at a splice encapsulated within the potting material.
Clause 22: The shock control cable assembly of any of clauses 16 through 21, wherein the potting material is a two-part unfilled epoxy adhesive that cures to polymers, and the routing guide is formed from nylon.
Clause 23: The shock control cable assembly of any of clauses 16 through 22, wherein the first shock of the vehicle is a rear shock and the second shock of the vehicle is a center shock.
Clause 24: The shock control cable assembly of any clauses 16 through 23, wherein the vehicle is a snowmobile.
Clause 25: A method of routing control signals from a shock control module of a vehicle to a first shock and a second shock, comprising: providing a routing guide having a channel, a clip and a flange; forming a main cable to extend from the shock control module to the routing guide; forming a first shock cable to extend from the first shock of the vehicle to the routing guide; forming a second shock cable to extend from the second shock of the vehicle to the routing guide; routing conductors of the main cable, the first shock cable, and the second shock cable into the routing guide; connecting the conductors of the main cable to the conductors of the first shock cable and the conductors of the second shock cable; inserting the connected conductors into the channel of the routing guide; placing the routing guide in a fixture; injecting potting material into the channel to encapsulate the connected conductors; clipping the clip of the routing guide to a first member of a rear suspension of the vehicle to position the routing guide; installing a bolt through the flange of the routing guide into a second member of the rear suspension to secure the routing guide; connecting the main cable to the shock control module; connecting the first shock cable to the first shock; and connecting the second shock cable to the second shock.

What is claimed is:

1. A shock control cable assembly for a vehicle, comprising:
a routing guide including a channel configured to receive conductors of a main cable configured to connect to a shock control module, conductors of a first shock cable configured to connect to a first shock of the vehicle, and conductors of a second shock cable configured to connect to a second shock of the vehicle, at least one of the conductors of the main cable being connected to each of the first shock cable and the second shock cable within the channel, the routing guide further including a first flange having a first opening to receive a first fastener to secure the routing guide to a first member of a rear suspension of the vehicle; and
potting material injected into the channel to encapsulate the conductors of the main cable, the conductors of the first shock cable, and the conductors of the second shock cable to protect the conductors from environmental conditions.

2. The shock control cable assembly of claim 1, wherein the routing guide includes a main body having an upper wall, a lower wall, and a connecting wall extending between the upper wall and the lower wall, wherein together the upper wall, the lower wall, and the connecting wall define the channel.

3. The shock control cable assembly of claim 2, wherein the upper wall includes a clip configured to attach the routing guide to a second member of the rear suspension.

4. The shock control cable assembly of claim 2, wherein the upper wall includes a first opening configured to receive the first shock cable for a first vehicle and a second opening configured to receive the first shock cable for a second vehicle.

5. The shock control cable assembly of claim 2, wherein the upper wall, the lower wall, and the connecting wall define an outlet configured to receive the second shock cable.

6. The shock control cable assembly of claim 2, wherein the first flange extends from the lower wall of the routing guide.

7. The shock control cable assembly of claim 6, wherein the routing guide includes a second flange extending from the lower wall, the second flange including a second opening to receive a second fastener to secure the routing guide to the first member of the rear suspension.

8. The shock control cable assembly of claim 2, wherein the routing guide further includes an inlet arm extending from the main body, the inlet arm having a main cable opening configured to receive the main cable.

9. The shock control cable assembly of claim 8, wherein the inlet arm includes a junction extending from the main body and an extension extending from the junction substantially perpendicular to the main body, the extension having a clip shaped wall configured to attach the routing guide to a third member of the rear suspension.

10. The shock control cable assembly of claim 1, wherein the routing guide further includes a second flange having a second opening to receive a second fastener to secure the routing guide to the first member of the rear suspension, a clip configured to attach the routing guide to a second member of the rear suspension, and a clip shaped wall configured to attach the routing guide to a third member of the rear suspension.

11. The shock control cable assembly of claim 10, wherein the first member of the rear suspension is a plate of an H bracket assembly, the second member is a front tube of the H bracket assembly, and the third member is a rear tube of the H bracket assembly.

12. The shock control cable assembly of claim 1, wherein the at least one of the conductors of the main cable is a common power conductor, the common power conductor being connected to the first shock cable and the second shock cable at a splice encapsulated within the potting material.

13. The shock control cable assembly of claim 1, wherein the potting material is a two-part unfilled epoxy adhesive that cures to polymers, and the routing guide is formed from nylon.

14. The shock control cable assembly of claim 1, wherein the first shock of the vehicle is a rear shock and the second shock of the vehicle is a center shock.

15. The shock control cable assembly of claim 1, wherein the vehicle is a snowmobile.

16. A shock control cable assembly for a vehicle, comprising:
a main cable having a first end, a second end, and a first connector at the first end, the first connector being adapted to connect to a shock control module of the vehicle;
a first shock cable having a first end, a second end, and a second connector at the first end, the second connector being adapted to connect to a first shock of the vehicle;
a second shock cable having a first end, a second end, and a third connector at the first end, the third connector being adapted to connect to a second shock of the vehicle;
a routing guide including a main body and an inlet arm;
wherein the main body includes:
an upper wall including a clip configured to attach to a first member of a rear suspension of the vehicle and a first opening which receives the second end of the first shock cable;
a lower wall including a first flange having an opening configured to receive a fastener to secure the main body to a second member of the rear suspension;
a connecting wall extending between the upper wall and the lower wall, the upper wall, the lower wall, and the connecting wall together defining a channel; and
an outlet formed by the upper wall, the lower wall, and the connecting wall, the outlet receiving the second end of the second shock cable;
wherein the inlet arm includes a second opening which receives the second end of the main cable;
wherein the second end of the main cable is connected to the second end of the first shock cable and the second end of the second shock cable within the channel of the main body of the routing guide; and
potting material injected into the channel of the main body to encapsulate the second end of the main cable, the second end of the first shock cable, and the second end of the second shock cable.

17. The shock control cable assembly of claim 16, wherein the upper wall includes a second opening configured to receive the first shock cable.

18. The shock control cable assembly of claim 16, wherein the routing guide includes a second flange extending from the lower wall, the second flange including a second opening to receive a second fastener to secure the routing guide to the second member of the rear suspension.

19. The shock control cable assembly of claim 16, wherein the inlet arm includes a junction extending from the main body and an extension extending from the junction substantially perpendicular to the main body, the extension having a clip shaped wall configured to attach the routing guide to a third member of the rear suspension.

20. The shock control cable assembly of claim 19, wherein the first member of the rear suspension is a front tube of an H bracket assembly, the second member is a plate of the H bracket assembly, and the third member is a rear tube of the H bracket assembly.

21. The shock control cable assembly of claim 16, wherein the main cable includes a common power conductor, the common power conductor being connected to the first shock cable and the second shock cable at a splice encapsulated within the potting material.

22. The shock control cable assembly of claim 16, wherein the potting material is a two-part unfilled epoxy adhesive that cures to polymers, and the routing guide is formed from nylon.

23. The shock control cable assembly of claim 16, wherein the first shock of the vehicle is a rear shock and the second shock of the vehicle is a center shock.

24. The shock control cable assembly of claim 16, wherein the vehicle is a snowmobile.

25. A method of routing control signals from a shock control module of a vehicle to a first shock and a second shock, comprising:
providing a routing guide having a channel, a clip and a flange;
forming a main cable to extend from the shock control module to the routing guide;
forming a first shock cable to extend from the first shock of the vehicle to the routing guide;
forming a second shock cable to extend from the second shock of the vehicle to the routing guide;
routing conductors of the main cable, the first shock cable, and the second shock cable into the routing guide;
connecting the conductors of the main cable to the conductors of the first shock cable and the conductors of the second shock cable;
inserting the connected conductors into the channel of the routing guide;
placing the routing guide in a fixture;
injecting potting material into the channel to encapsulate the connected conductors;
clipping the clip of the routing guide to a first member of a rear suspension of the vehicle to position the routing guide;
installing a bolt through the flange of the routing guide into a second member of the rear suspension to secure the routing guide;
connecting the main cable to the shock control module;
connecting the first shock cable to the first shock; and
connecting the second shock cable to the second shock.
